(19) United States
(12) Patent Application Publication
(10) Pub. No.: US 2026/0341971 A1
(43) Pub. Date: Oct. 29, 2026

(54) GEODESIC LENS ANTENNA WITH TWISTED WAVEGUIDE

(71) Applicant: Sony Group Corporation, Tokyo (JP)

(72) Inventors: Kun ZHAO, Malmö (SE); Wenfu FU, Solna (SE); Qiao CHEN, Göteborg (SE); Oscar QUEVEDO-TERUEL, Stockholm (SE)

(21) Appl. No.: 19/101,567

(22) PCT Filed: Aug. 23, 2023
(86) PCT No.: PCT/EP2023/073158

§ 371 Date: Feb. 5, 2025

(30) Foreign Application Priority Data
Aug. 26, 2022 (SE) 2250997-0

(51) Int. Cl. H01Q 15/04

(52) U.S. Cl. CPC H01Q 15/04

(57) ABSTRACT

Examples disclose an antenna comprising a body, wherein the body encloses a first cavity (920, 930, 940) having conductive walls and including a first geodesic lens portion, a first lens feeding waveguide portion (940), a first antenna feeding waveguide portion (920) wherein the first antenna feeding waveguide portion (920) has a first rectangular cross-section, wherein a height of the first rectangular cross-section in a direction parallel to a rotational symmetry axis of the first geodesic lens portion is greater than a width of the first rectangular cross-section, wherein the first lens feeding waveguide portion (940) has a second rectangular cross-section, wherein a height of the second rectangular cross-section in a direction parallel to the rotational symmetry axis of the first geodesic lens portion is smaller than a width of the second rectangular cross-section, wherein the first cavity (920, 930, 940) includes a waveguide conversion portion (930) between the first antenna feeding waveguide portion (920) and the first geodesic lens feeding waveguide portion (940), wherein the waveguide conversion portion (930) comprises two overlapping rectangular cuboid cavities, wherein a depth of each rectangular cuboid cavities corresponds to a depth of the waveguide conversion portion (930), wherein a height of the waveguide conversion portion (930) corresponds to the height of the first rectangular cross-section, and wherein a width of the waveguide conversion portion (930) corresponds to the width of the second rectangular cross-section.

### TECHNICAL FIELD

Various examples generally relate to antennas.

### BACKGROUND

Modern wireless communication systems are intended to operate in the THz and sub-THz frequency range. For example, sub-THz (100 to 300 GHz) and THz radiation (300 to 3000 GHz) may possibly be used in sixth generation mobile systems (6G) as developed by the 3rd Generation Partnership Project (3GPP).

Implementing phased array antenna designs proves to be challenging at these frequency ranges. The antenna elements and inter-element distances become very small rendering it difficult to fit RF components.

Algaba-Brazález, Astrid, et al. “Compact Polarization Transformation in a Geodesic Luneburg Lens Antenna.” 2021 IEEE International Symposium on Antennas and Propagation and USNC-URSI Radio Science Meeting (APS/URSI). IEEE, 2021 and and Quevedo-Teruel, Oscar, et al. “Geodesic lens antennas for 5G and beyond.” IEEE Communications Magazine 60.1(2022 ): 40-45 propose to use lens antennas instead.

### SUMMARY

There may be a need for antennas providing high efficiency when adapting established wireless communication techniques to the THz and sub-THz frequency range.

Said need has been addressed with the subject-matter of the independent claim. Advantageous embodiments are described in the dependent claims.

Examples disclose an antenna comprising a body, wherein the body encloses a first cavity having conductive walls and including a first geodesic lens portion, a first lens feeding waveguide portion, a first antenna feeding waveguide portion, wherein the first antenna feeding waveguide portion has a first rectangular cross-section, wherein a height of the first rectangular cross-section in a direction parallel to a rotational symmetry axis of the first geodesic lens portion is greater than a width of the first rectangular cross-section, wherein the first lens feeding waveguide portion has a second rectangular cross-section, wherein a height of the second rectangular cross-section in a direction parallel to the rotational symmetry axis of the first geodesic lens portion is smaller than a width of the second rectangular cross-section, wherein the first cavity includes a waveguide conversion portion between the first antenna feeding waveguide portion and the first geodesic lens feeding waveguide portion, wherein the waveguide conversion portion comprises two overlapping rectangular cuboid cavities, wherein a depth of each rectangular cuboid cavities corresponds to a depth of the waveguide conversion portion, wherein a height of the waveguide conversion portion corresponds to the height of the first rectangular cross-section, and wherein a width of the waveguide conversion portion corresponds to the width of the second rectangular cross-section.

### BRIEF DESCRIPTION OF THE DRAWINGS

FIG. 1 schematically illustrates an antenna.

FIG. 2 schematically illustrates a geodesic lens portion and an aperture portion.

FIG. 3 schematically illustrates an antenna in a cross-sectional view.

FIG. 4 schematically illustrates the antenna of FIG. 3 in a perspective 3D view.

FIG. 5 schematically illustrates a portion of the antenna of FIG. 3.

FIG. 6 schematically illustrates cross-polarization discrimination.

FIG. 7 schematically illustrates a waveguide having a rectangular cross section.

FIG. 8 schematically illustrates a waveguide having a rectangular cross section.

FIG. 9 schematically illustrates an antenna in a partially cut view.

FIG. 10 schematically illustrates a waveguide conversion portion of the antenna of FIG. 9.

FIG. 11 schematically illustrates the waveguide conversion portion of FIG. 10.

FIG. 12 schematically illustrates the waveguide conversion portion of FIG. 10.

FIG. 13 schematically illustrates the effect of a waveguide conversion portion.

### DETAILED DESCRIPTION

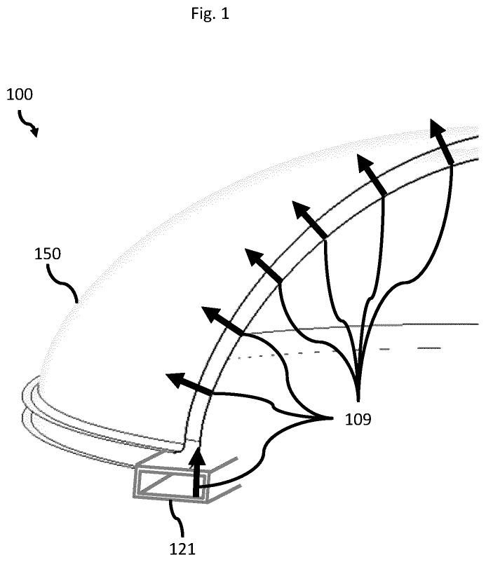

FIG. 1 schematically illustrates an antenna 100. The antenna 100 comprises an antenna feeding waveguide portion 121 and a geodesic lens portion 150, wherein the arrows 109 indicate the direction of the electric field E.

An antenna 100 comprising a lens portion 150 may transform a spherical wave front excited by an antenna feeding portion, in particular an antenna feeding waveguide portion 121, to a plane wave front. Thus, such an antenna 100 may reach a high gain in the far field.

Typically, an antenna 100 including a lens portion 150 comprises a plurality of antenna feeding waveguide portions 121 arranged around the circumference of the geodesic lens portion 150. By feeding the signal through different antenna feeding waveguide portions, beam steering may be realized.

An antenna 100 comprising a geodesic lens portion 150 may be a good option among other possible lens portions. The geodesic lens portion makes use of a physical path that mimics an equivalently graded refractive index. Therefore, unlike conventional lenses, geodesic lens portions 150 may be implemented in a fully-metallic configuration using parallel plate waveguides (PPW). Geodesic lens portions 150 implemented in the form of PPWs may lead to fewer losses compared to lens portions using dielectric materials. Geodesic lens portions 150 may mimic the properties of graded-index lenses and may provide wide-angle scanning capabilities with reduced scan losses.

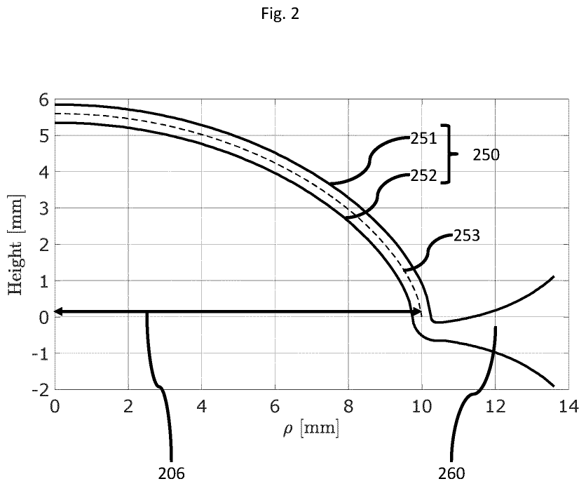

FIG. 2 illustrates the cross-section of a geodesic lens portion 250 and an aperture portion 260 of an antenna. The geodesic lens portion 250 may be implemented using two parallel plates 251, 252 forming a PPW. A geodesic lens curve 253 may describe the form of the PPW. The diameter 206 of approximately 10 mm may correspond to four times the wavelength at 120 GHz. Different diameters can be used corresponding to respective wavelengths. FIG. 2 shows that the dimensions of such an antenna are compatible with the size of an access node (AN) and/or wireless device also called user equipment (UE) of a modern communication network.

### A Compact Geodesic Lens Antenna With Two Cavities

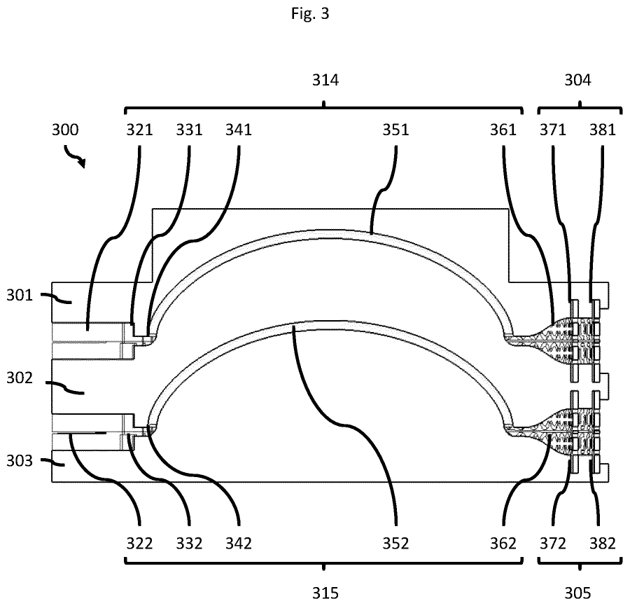

FIG. 3 illustrates an antenna 300 comprising a body enclosing a first cavity 314 and a second cavity 315. The body may include a first body portion 301, a second body portion 302 and/or a third body portion 303. The first cavity 314 and the second cavity 315 may have equal dimensions. The first cavity 314 has conductive walls and includes a first geodesic lens portion 351, a first lens feeding waveguide portion 341, a first aperture portion 361, and a first antenna feeding waveguide portion 321. Likewise the second cavity 315 comprises a second geodesic lens portion 352, a second lens feeding waveguide portion 342, a second aperture portion 362, and a second antenna feeding waveguide portion 322.

The first antenna feeding waveguide portion 321 and the second antenna feeding waveguide portion 322 may allow for connecting external waveguides to the antenna 300. The first antenna feeding waveguide portion 321 and the second antenna feeding waveguide portion 322 may receive the signals to be transmitted by the antenna 300 and/or transmit the signals received by the antenna 300.

The first cavity 314 and the second cavity 315 are stacked. A height of the first geodesic lens portion 351 is larger than a distance between an upper wall of the first lens feeding waveguide portion 341 and an upper wall of the second lens feeding waveguide portion 342 of the second cavity 315. Thus, the first cavity 314 and the second cavity 315 are provided very close to each other such that signals emitted via the first aperture portion 361 and signals emitted via the second aperture portion 362 may be considered to be emitted from essentially the same location. This may be particularly useful if signals emitted via the first aperture portion 361 have a first polarization and signals emitted via the second aperture portion 362 have a second polarization which is orthogonal to the first polarization. Thus, the antenna 300 may facilitate polarization multiplexing.

### Geodesic Lens Antenna With Improved Polarizer

A first polarizer 304 may be arranged in the first aperture portion 361. As shown in FIGS. 3, 4 and 5, the first polarizer 304 may include a first polarizer screen 381. The first polarizer screen 381 comprises a first row of polarizing elements 491 and at least a second row of polarizing elements. The polarizing element 491 of the first row and the second row are arranged periodically along a circumference of the first geodesic lens portion 351. Using a first row and at least a second row of polarizing elements 491 may lead to a more continuous boundary condition in the vertical direction which is more similar to an ideal periodic boundary condition. Accordingly, the first polarizer 304 may show superior polarization performance compared to known polarizers. Using more rows of polarizing elements for the first polarizer screen 381 of the first polarizer 304 may further enhance the performance. Restricting the number of rows to two may present an optimal comprise between polarizer performance and the physical dimensions of the first polarizer 304.

A distance between two neighboring polarizing elements 491 of the first row may be equal to the distance between polarizing elements of the first row and polarizing elements of the second row.

The first polarizer 304 may be a linear polarizer.

A first polarization axis of the first polarizer screen 304 may be oriented 45° with respect to a rotational symmetry axis of the first geodesic lens portion 351. The antenna 304 may have poor transmission properties for signals having a polarization horizontal to the first aperture portion 361 compared to signals having a polarization vertical to the first aperture portion 361. In particular, strong reflection may happen in the case of signals having a polarization horizontal to the first aperture portion 361. Using a 45° orientation may enable an antenna 300 with a first cavity 314 and a stacked same second cavity 315 to radiate with orthogonal polarizations while keeping the radiation properties of the first cavity 314 and the second cavity 315 essentially the same.

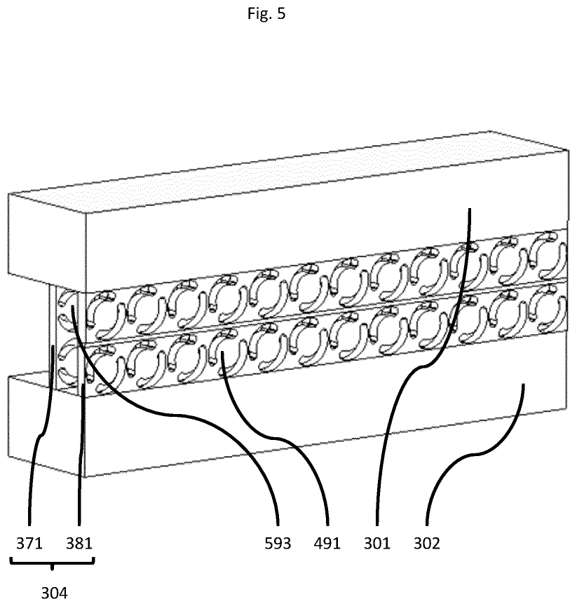

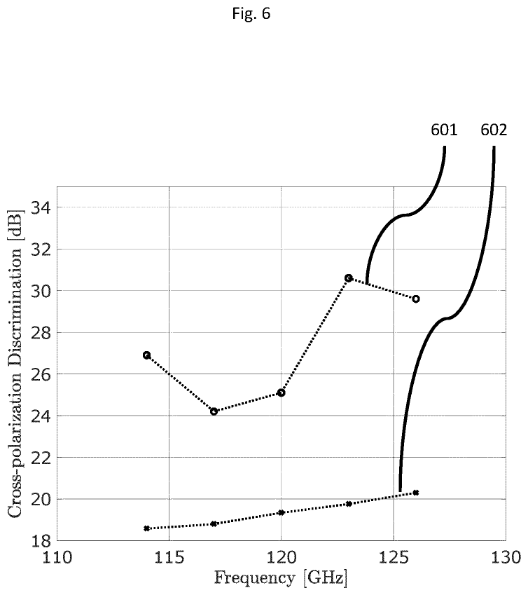

FIG. 6 shows the cross-polarization discrimination in dB over the frequency in GHz for an antenna using a polarizing screen comprising a single row of polarization elements (602) and for an antenna using a polarizing screen comprising two rows of polarization elements (601). The two rows of polarizing elements 491, 492 of the polarizing screens 381, 382 improve the cross-polarization level significantly.

As shown in FIGS. 3 and 5, the first polarizer 304 may comprise a second polarizer screen 371. The second polarizer screen 371 may be arranged between the first geodesic lens portion 351 and the first polarizer screen 381. A second polarization axis of the second polarizer screen 371 may be arranged between the first polarization axis and the rotational symmetry axis of the first geodesic lens portion 351. The second polarizer screen 371 may help to further improve the cross-polarization level. A distance between the first polarizer screen 381 and the second polarizer screen 371 may be between a quarter and a half of the height of the first lens feeding waveguide portion 341. Thus, the distance between the first polarizer screen 381 and the second polarizer screen 371 may be between a quarter and a half of the wavelength at which the antenna 300 is to operate.

As stated before, the body of the antenna 300 may comprise a first body portion 301 and a second body portion 302. The first body portion 301 may comprise a first indention forming an upper part of the first cavity. The second body portion 302 may comprise a second indention forming a lower part of the first cavity 314. Thus, only two body portions 301, 302 may be required for forming the first cavity 314. The limited number of interfaces between body portions of the body of the antenna 300 reduces the risk of unintended transmission losses.

The first indention and/or the second indention may be undercut-free. This may facilitate manufacturing of the antenna 300.

The first body portion 301 may comprise a first slit, wherein the first polarizer screen 381 is accommodated in the first slit. The first polarizer screen 381 may be very thin with fine textures. Manufacturing the first polarizer screen 381 separately from the body of the antenna 300 may be less challenging. The first slit may facilitate assembling the antenna 300. In particular, the first slit may permit accurate positioning of the first polarizer screen 381. The assembled antenna 300 may be mechanically robust. For example, the first polarizer screen 381 accommodated in the first slit may experience fewer vibrations.

The depth of the first slit may correspond to an odd multiple of half the height of the first lens feeding waveguide portion 321. This may minimize the impact on the electromagnetic characteristics. In particular, the height of the first lens feeding waveguide portion 321 may correspond to a wavelength of a transmission frequency of the antenna 300. The height of the first lens feeding waveguide portion 321 may correspond to the distance between the two plates of the PPW forming the first geodesic lens portion 351. The proposed technique for integrating a vertical screen/iris into a PPW is not restricted to antenna comprising geodesic lens portion may be applicable to other parallel-plate based devices, too.

At least one of the first body portion 301 and the second body portion 302 may be formed by milling or casting or 3D-printing. Milling may allow for an antenna having very precise dimensions. Casting may be very suitable for manufacturing antenna in larger quantities. 3D-printing may be particular useful when antennas adapted for very specific frequencies shall be manufactured. The first polarizer screen 381 may be formed by waterjet cutting or laser cutting.

Using two rows of polarizing elements 491, 492 as proposed above may also facilitate the integration of the polarizing screens 371, 372, 381, 382 within the first aperture portion 361 and the second aperture portion 362. The height of each row of polarizing elements 491, 492 may correspond to about 1 mm at sub-Terahertz frequencies. A smaller height than 1 mm be used if the antenna is to operate at frequencies above 120 GHz. It may also be possible to implement heights above 1 mm. Using two rows of polarizing elements 491, 492 increases the physical dimensions of the polarizing screens 371, 372, 381, 382 and, thus, permits more tolerances for manufacturing and assembly errors.

### Geodesic Lens Antenna with Twisted Waveguide

As illustrated in FIG. 1, a lens feeding waveguide portion 121 with a rectangular cross-section feeding a geodesic lens portion 150 should have a height in a direction parallel to the rotational symmetry axis of the first geodesic lens portion which is smaller than a width of the rectangular cross-section, in order to avoid losses when feeding the geodesic lens portion. In particular, the height advantageously corresponds approximately to the distance of the PPW forming the geodesic lens portion.

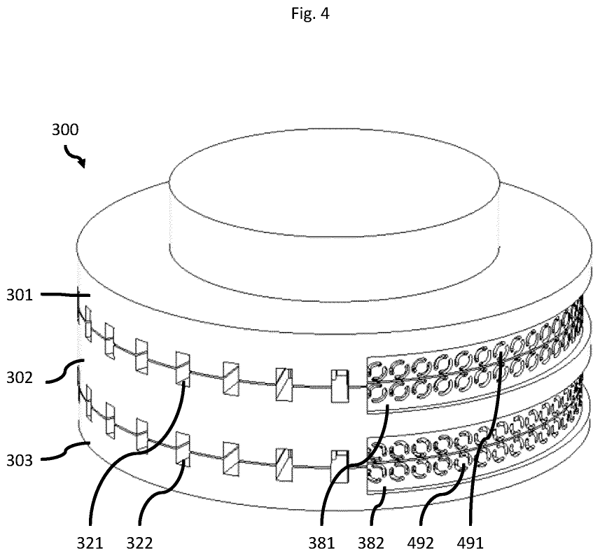

Moreover, as explained with reference to FIGS. 3 and 4, using a body comprising a first body portion 301 and 302 for forming the first cavity substantially simplifies manufacturing the antenna.

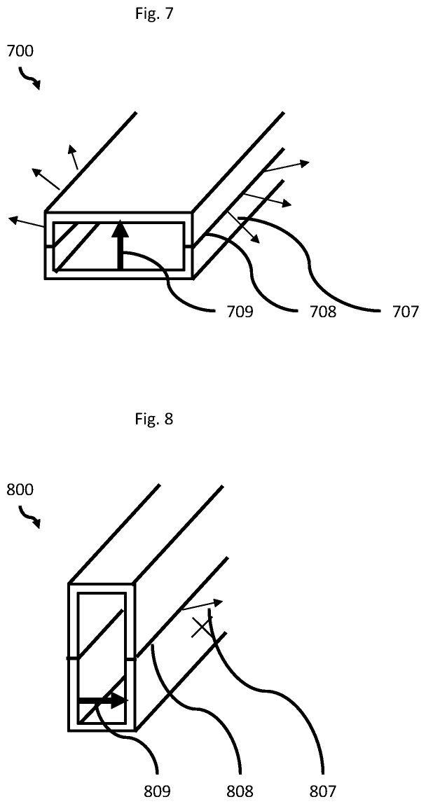

However, the parting line between the first body portion and the second body portion induces a slit 708 in the lens feeding portion 121, 700 illustrated in greater detail in FIG. 7. Due to the orientation of the E-field, even a very small slit 708 leads to substantial outward radiation 707 at the intended THz/sub-THz frequency ranges. Longer feeding waveguide portions 321, 341 lead to increased radiation losses. However, a certain length of the feeding waveguide portions 321, 341 is required to allow for enough space at the circumference of the antenna to allow for connecting external waveguides.

In case the slit 808 is provided at the longer side of a waveguide 800, as shown in FIG. 8, the radiation losses 807 are reduced substantially.

Thus, proposed herein is an antenna 300 comprising a body 301, 302, 303, wherein the body 301, 302, 303 encloses a first cavity 314 having conductive walls. The first cavity 314 includes a first geodesic lens portion, a first lens feeding waveguide portion and a first antenna feeding waveguide portion 321. The first antenna feeding waveguide portion 321 has a first rectangular cross-section, wherein a height of the first rectangular cross-section in a direction parallel to a rotational symmetry axis of the first geodesic lens portion 351 is greater than a width of the first rectangular cross-section. The first lens feeding waveguide portion 341 has a second rectangular cross-section. A height of the second rectangular cross-section in a direction parallel to the rotational symmetry axis of the first geodesic lens portion 351 is smaller than a width of the second rectangular cross-section. The first cavity 314 further includes a waveguide conversion portion 331 between the first antenna feeding waveguide portion 321 and the first geodesic lens feeding waveguide portion 341. The waveguide conversion portion 341 may be considered as a portion rotating an E-plane waveguide to an H-plane waveguide.

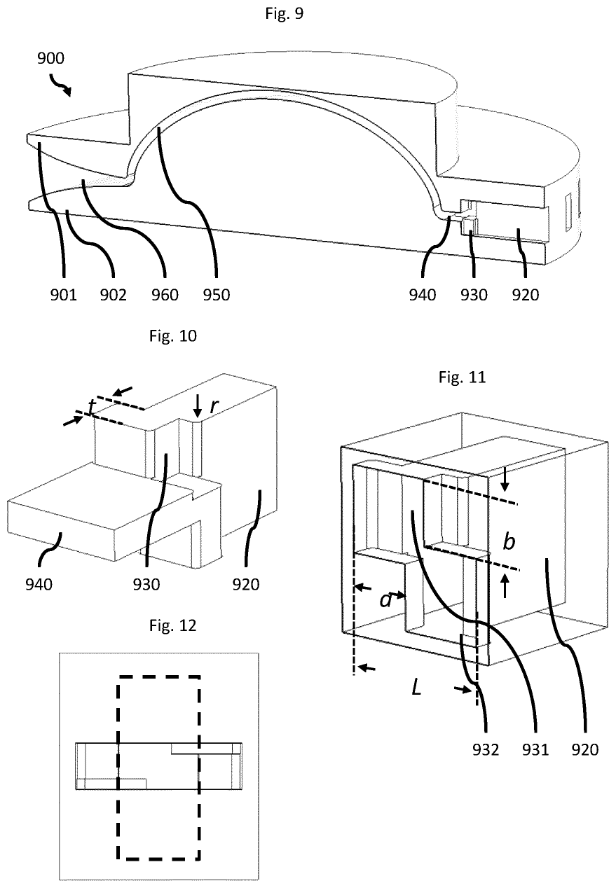

Further details of a waveguide conversion portion 940 are illustrated in FIG. 9 to 12. FIG. 9 illustrates an antenna 900 comprising a body including a first body portion 901 and a second body portion 902. The body 901, 902 encloses a first cavity having conductive walls and including a first geodesic lens portion 950, a first lens feeding waveguide portion 940, and a first antenna feeding waveguide portion 920. The first antenna feeding waveguide portion 920 has a first rectangular cross-section. A height of the first rectangular cross-section in a direction parallel to a rotational symmetry axis of the first geodesic lens portion 950 is greater than a width of the first rectangular cross-section. The first lens feeding waveguide portion 940 has a second rectangular cross-section. A height of the second rectangular cross-section in a direction parallel to the rotational symmetry axis of the first geodesic lens portion 950 is smaller than a width of the second rectangular cross-section. The first cavity includes a waveguide conversion portion 930 between the first antenna feeding waveguide portion 920 and the first geodesic lens feeding waveguide portion 940.

The waveguide conversion portion 930 may comprise two overlapping rectangular cuboid cavities 931, 932. A depth of each rectangular cuboid cavities 931, 932 may correspond to a depth of the waveguide conversion portion 930. A height of the waveguide conversion portion may correspond to the height of the first rectangular cross-section. A width of the waveguide conversion portion 930 may correspond to the width of the second rectangular cross-section.

In examples, the depth t of the waveguide conversion portion 930 may be between 0.6 and 0.8 mm, in particular 0.7 mm. A width offset a of the rectangular cuboid cavities 931, 932 may be between 0.8 and 0.9 mm, in particular 0.86 mm. A height offset b of the rectangular cuboid cavities 931, 932 may be between 0.8 and 0.9 mm, in particular 0.88 mm. The width of the first rectangular cross-section may be between 0.9 and 1.1 mm, in particular 1.018 mm. The height of the second rectangular cross-section may be between 0.4 and 0.6 mm, in particular 0.5 mm. A width of the second rectangular cross-section may be between 1.9 and 2.1 mm, in particular 2.036 mm. The rectangular cuboid cavities 931, 932 may comprise rounded edges. In examples, a blend radius of the rounded edges may be between 0.05 and 0.15, in particular 0.15 mm. The given values may be particularly useful if the antenna 900 is to operate at a frequency of about 120 GHz corresponding to a wavelength of about 2.5 mm.

An upper wall of the waveguide conversion portion 930 may align with an upper wall of the first antenna feeding waveguide portion 920. A lower wall of the waveguide conversion portion 930 may align with a lower wall of the first antenna feeding waveguide portion 920.

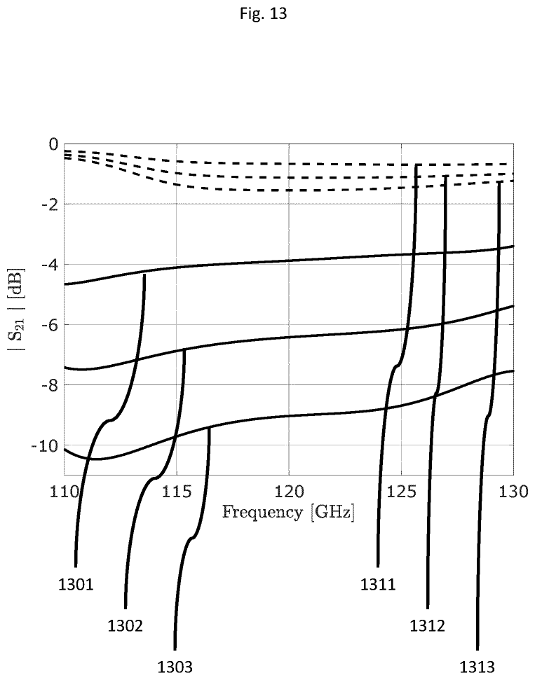

FIG. 13 compares the performance of feeding waveguides 1311, 1312, 1313 comprising an E-plane antenna feeding waveguide portion, a waveguide conversion portion and an H-plane lens feeding portion with feeding waveguides 1301, 1302, 1303 only comprising an H-plane waveguide for three different slit sizes 0.03 mm, 0.05 mm and 0.07 mm. For the largest gap size 0.07 mm, the difference in performance is the greatest, but also for the other two estimate slit sizes the benefit of the waveguide conversion portion is very significant.

Hence, antennas have been proposed allowing for dual polarized operation with improved cross-polarization level. Moreover, antennas have been disclosed having reduced power leakage on the feeding part. Furthermore, the antennas have been shown to be mechanically robust and easy to manufacture at low costs.

Summarizing, at least the following EXAMPLES have been described above:

### EXAMPLE 1

An antenna (300; 900) comprising a body (301, 302, 303; 901, 902),
wherein the body (301, 302, 303; 901, 902) encloses
   a first cavity (314; 920, 930, 940, 950, 960) having conductive walls and including
      a first geodesic lens portion (351; 950),
      a first lens feeding waveguide portion (341; 940),
a first antenna feeding waveguide portion (321; 920)
   wherein the first antenna feeding waveguide portion (321; 920) has a first rectangular cross-section,
   wherein a height of the first rectangular cross-section in a direction parallel to a rotational symmetry axis of the first geodesic lens portion (351; 950) is greater than a width of the first rectangular cross-section,
   wherein the first lens feeding waveguide portion (341; 940) has a second rectangular cross-section,
   wherein a height of the second rectangular cross-section in a direction parallel to the rotational symmetry axis of the first geodesic lens portion (351; 950) is smaller than a width of the second rectangular cross-section,
   wherein the first cavity (314; 920, 930, 940, 950) includes a waveguide conversion portion (331; 930) between the first antenna feeding waveguide portion (321; 920) and the first geodesic lens feeding waveguide portion (341; 940),
   wherein the waveguide conversion portion (331; 930) comprises two overlapping rectangular cuboid cavities (931, 932),
   wherein a depth of each rectangular cuboid cavities (931, 932) corresponds to a depth of the waveguide conversion portion (930),
   wherein a height of the waveguide conversion portion (930) corresponds to the height of the first rectangular cross-section, and
   wherein a width of the waveguide conversion portion (930) corresponds to the width of the second rectangular cross-section.

### EXAMPLE 2

The antenna (300, 900) of example 1,
wherein the depth (t) of the waveguide conversion portion (331; 930) is between 0.6 and 0.8 mm.

### EXAMPLE 3

The antenna (300, 900) of any one of examples 1 to 2,
wherein a height offset (b) of the rectangular cuboid cavities (931, 932) is between 0.8 and 0.9 mm, in particular 0.88 mm.

### EXAMPLE 4

The antenna (300, 900) of any one of examples 1 to 3,
wherein the rectangular cuboid cavities (931, 932) comprise rounded edges.

### EXAMPLE 5

The antenna (300, 900) of example 4,
wherein a blend radius of the rounded edges is between 0.05 and 0.15 mm, in particular 0.1 mm.

### EXAMPLE 6

The antenna (300, 900) of any one of examples 1 to 5,
wherein an upper wall of the waveguide conversion portion (331; 930) aligns with an upper wall of the first antenna feeding waveguide portion (321; 920).

### EXAMPLE 7

The antenna (300, 900) of any one of examples 1 to 6,
wherein a lower wall of the waveguide conversion portion (331; 930) aligns with a lower wall of the first antenna feeding waveguide portion (321; 920).

### EXAMPLE 8

The antenna (300, 900) of any one of examples 1 to 7,
wherein at least one lateral wall of the waveguide conversion portion (331; 930) aligns with a lateral wall of the first lens feeding waveguide portion (341; 940).

### EXAMPLE 9

The antenna (300, 900) of any one of examples 1 to 8,
wherein the body (301, 302, 303; 901, 902) comprises a first body portion (301, 901) and a second body portion (302, 902),
wherein the first body portion (301; 901) comprises a first indention forming an upper part of the first cavity (314; 920, 930, 940, 950, 960),
wherein the second body portion (302, 902) comprises a second indention forming a lower part of the first cavity (314; 920, 930, 940, 950, 960).

### EXAMPLE 10

The antenna (300, 900) of example 9,
wherein the first indention and/or the second indention are undercut-free.

1. An antenna comprising a body, wherein the body encloses
a first cavity having conductive walls and including
a first geodesic lens portion,
a first lens feeding waveguide portion,
a first antenna feeding waveguide portion,
wherein the first antenna feeding waveguide portion has a first rectangular cross-section,
wherein a height of the first rectangular cross-section in a direction parallel to a rotational symmetry axis of the first geodesic lens portion is greater than a width of the first rectangular cross-section,
wherein the first lens feeding waveguide portion has a second rectangular cross-section,
wherein a height of the second rectangular cross-section in a direction parallel to the rotational symmetry axis of the first geodesic lens portion is smaller than a width of the second rectangular cross-section,
wherein the first cavity includes a waveguide conversion portion between the first antenna feeding waveguide portion and the first geodesic lens feeding waveguide portion,
wherein the waveguide conversion portion comprises two overlapping rectangular cuboid cavities,
wherein a depth of each rectangular cuboid cavities corresponds to a depth of the waveguide conversion portion,
wherein a height of the waveguide conversion portion corresponds to the height of the first rectangular cross-section, and
wherein a width of the waveguide conversion portion corresponds to the width of the second rectangular cross-section.

2. The antenna of claim 1,
wherein the depth of the waveguide conversion portion is between 0.6 and 0.8 mm.

3. The antenna of claim 1,
wherein a width offset (a) of the rectangular cuboid cavities is between 0.8 and 0.9 mm, in particular 0.86 mm.

4. The antenna of claim 1,
wherein a height offset of the rectangular cuboid cavities is between 0.8 and 0.9 mm, in particular 0.88 mm.

5. The antenna of claim 1,
wherein the height of the first rectangular cross-section is between 1.9 and 2.1 mm, in particular 2.036 mm.

6. The antenna of claim 1, wherein
the width of the first rectangular cross-section is between 0.9 and 1.1 mm, in particular 1.018 mm.

7. The antenna of claim 1, wherein
the height of the second rectangular cross-section is between 0.4 and 0.6 mm, in particular 0.5 mm.

8. The antenna of claim 1, wherein
the width of the second rectangular cross-section is between 1.9 and 2.1 mm, in particular 2.036 mm.

9. The antenna of claim 1, wherein the rectangular cuboid cavities comprise rounded edges.

10. The antenna of claim 9,
wherein a blend radius of the rounded edges is between 0.05 and 0.15 mm, in particular 0.1 mm.

11. The antenna of claim 1, wherein
an upper wall of the waveguide conversion portion aligns with an upper wall of the first antenna feeding waveguide portion.

12. The antenna of claim 1, wherein
a lower wall of the waveguide conversion portion aligns with a lower wall of the first antenna feeding waveguide portion.

13. The antenna of claim 1, wherein
at least one lateral wall of the waveguide conversion portion aligns with a lateral wall of the first lens feeding waveguide portion.

14. The antenna of claim 1,
wherein the body comprises a first body portion and a second body portion,
wherein the first body portion comprises a first indention forming an upper part of the first cavity,
wherein the second body portion comprises a second indention forming a lower part of the first cavity.

15. The antenna of claim 14,
wherein the first indention and/or the second indention are undercut-free.
